(19) United States
(12) Patent Application Publication
(10) Pub. No.: US 2006/0190681 A1
(43) Pub. Date: Aug. 24, 2006

(54) Scheduler for a disc drive apparatus

(75) Inventor: Alexander Cornelis Geerlings, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkllijke Philips Electronics N.V., Eindhoven (NL)

(21) Appl. No.: 10/539,376

(22) PCT Filed: Nov. 20, 2003
(86) PCT No.: PCT/IB03/05363

§ 371 Date: Jun. 15, 2005

(30) Foreign Application Priority Data
Dec. 19, 2002 (EP) 02080369.8

(51) Int. Cl. G06F 13/28

(52) U.S. Cl. 711/112

(57) ABSTRACT

A scheduler (10) for a user appliance (1) and a user appliance comprising such scheduler are provided, for cooperation with a disc storage device (20). The scheduler is designed to record or read user data into or from storage space of the disc storage device, at storage locations where the amount of noise generated is as little as possible. The scheduler has an associated memory (7) with information on the noise behavior of the disc storage device (20). When selecting a storage location for writing or reading, the scheduler is designed to consult the memory (7) and to select a low-noise storage area (43).

The present invention relates in general to a storage device comprising a rotary disc storage medium and an actuator moving a pickup over a disc surface for accessing different storage locations. Specifically, but not exclusively, the present invention relates to a hard disc storage device containing a magnetic storage disc; basically, however, the principles underlying the present invention are also applicable to optical storage devices.

As is commonly known, a storage disc comprises a plurality of tracks, either in the form of a continuous spiral or in the form of multiple concentric circles, of storage space where information may be stored in the form of a data pattern. For writing information in the storage space of the storage disc, or for reading information from the disc, a disc drive comprises, on the one hand, rotating means for rotating the disc, and on the other hand pickup means for scanning the storage tracks. Since the technology of storage discs in general, the way in which information can be stored in an optical or magnetic disc, and the way in which optical or magnetic data can be read from an optical or magnetic disc, is commonly known, it is not necessary here to describe this technology in more detail.

In the case of a magnetic disc, the pickup means typically comprise a magnetic head mounted on an actuator arm which is movable in a plane parallel to the disc surface. Usually, the actuator arm is pivotable with respect to an axis parallel to the disc rotation axis. The magnetic head is capable of converting an electrical signal to a magnetic field for magnetizing an area of the disc in order to write a data pattern (write operation), and is capable of converting magnetic field fluctuations to an electrical signal when reading back a data pattern (read operation).

During a write or read operation, audible noise is generated. Noise contributions may originate from several sources. The magnetic pickup interacts with the rotating disc, causing vibrations of the disc. A track following servo system, continuously adjusting the position of the actuator arm to keep the pickup on track, causes vibrations of the actuator arm, which are transferred mechanically to a carrying frame and a housing. Quick jumps from one track to another, indicated as “seek” action, cause a rattling noise of the actuator arm, which is likewise transferred mechanically to the carrying frame and the housing. These noises, depending on context, may be annoying to a user.

Therefore, a main objective of the present invention is to limit such noises.

The problem mentioned above is already described in, for instance, U.S. Pat. No. 6,396,653, which publication also describes quite elaborately the general constructional design of a hard disc drive. In order to reduce said problem, said document discloses a method for optimizing a velocity profile for use in seek actions, especially during idle operations, the method being performed by a controller within the hard disc device itself.

The phrase “optimizing” in the above means: optimizing with a view to minimum noise production. It may be that an amended velocity profile will result in reduced noise, but such method involves reduced accelerations and hence increased seek times, which is certainly not always acceptable.

The present invention proposes a different approach, which may be taken in stead of or in addition to the above prior art approach.

The present invention is particularly concerned with a consumer apparatus in which a hard disc drive unit (HDDU) is incorporated. By way of non-limiting example, a television apparatus is mentioned, incorporating a HDDU for storing sound and image (Audio/Video) of television programs. In such application, speed of data transfer is of great importance.

The HDDU can act as an AV recorder for recording TV programs, either for long-term storage (keeping a recording in archive), mid-term storage (keeping a recording for playback within a few days), or for short-term storage (playback while recording is still going on). It is noted that also in the case of long-term or mid-term storage, a new program may be recorded while an old program is played, in which case playback also occurs while recording is going on. The phrase short-term storage is used for a case when a user is watching a program but wishes to take a break while the program continues: the program is recorded, and when the user returns he wishes to continue watching where he has left. Then, a recording is played back a short delay time after having been recorded, the delay time corresponding to the duration of the user's break; consequently, also the jump distance for the pickup corresponds to the duration of the user's break. This type of combined write/read operation is also indicated as “time shift”.

In a straight-forward recording or playback operation, the number of seek actions can be relatively low, as writing or reading, respectively, can in principle be done in a “straight” line, i.e. always following one track. However, in the case of concurrent playback and recording, the number of seek actions will be relatively large, since the pickup continuously needs to jump back and forth from a write location to a read location.

In such consumer apparatus, any high level of “mechanical” noise is unacceptable. Therefore, there is a need to provide a consumer apparatus with built-in HDDU with reduced noise.

A storage location on disc can be characterized in terms of track number and sector number. A track number corresponds to a certain radial track location. It has been found that the level of noise generated depends, inter alia, on the radial location where the pickup is operating or jumping. Each HDDU has its own sound profile, representing the amount of noise as a function of place. However, in the case of several HDDUs of the same type, in practice the several sound profiles are very similar or even identical. Further, even when comparing different types of HDDUs with each other, the sound profiles are generally similar in that the noise level associated with mid-disc operation is substantially lower than the noise level associated with inner-disc or outer-disc operation. In this respect, the phrase “inner disc” relates to a disc area adjacent the innermost track, the phrase “outer disc” relates to a disc area adjacent the outermost track, and the phrase “mid-disc” relates to a central disc area around a central track.

In a consumer apparatus, a HDDU is a separate module, usually manufactured by a specialized HDD manufacturer, and usually interchangeable with other HDDUs. Data communication to and from the HDDU is performed by a scheduler of the consumer apparatus. When data is to be stored, the scheduler sends the data to the HDDU, and also sends a command regarding the desired storage location. The HDDU is expected to behave as an obedient slave to the scheduler, in that the data received is written at the location specified by the scheduler. Only if the target location specified by the scheduler appears to be defective, the HDDU is allowed to choose a reallocation location. The scheduler also notes where the data was stored. When this data is to be retrieved, the scheduler sends a read command to the HDDU, including information regarding the locations to read.

The present invention proposes to modify the scheduler such as to take into account the sound profile of the HDDU in cases where low noise production is important. Also, the scheduler may take into account circumstances like type of action to be performed, time of day, etc. For instance, in the case of a time-shift write/read operation, the scheduler may be designed to select the mid-disc area for recording.

These and other aspects, features and advantages of the present invention will be further explained by the following description of the present invention with reference to the drawings, in which same reference numerals indicate same or similar parts, and in which:

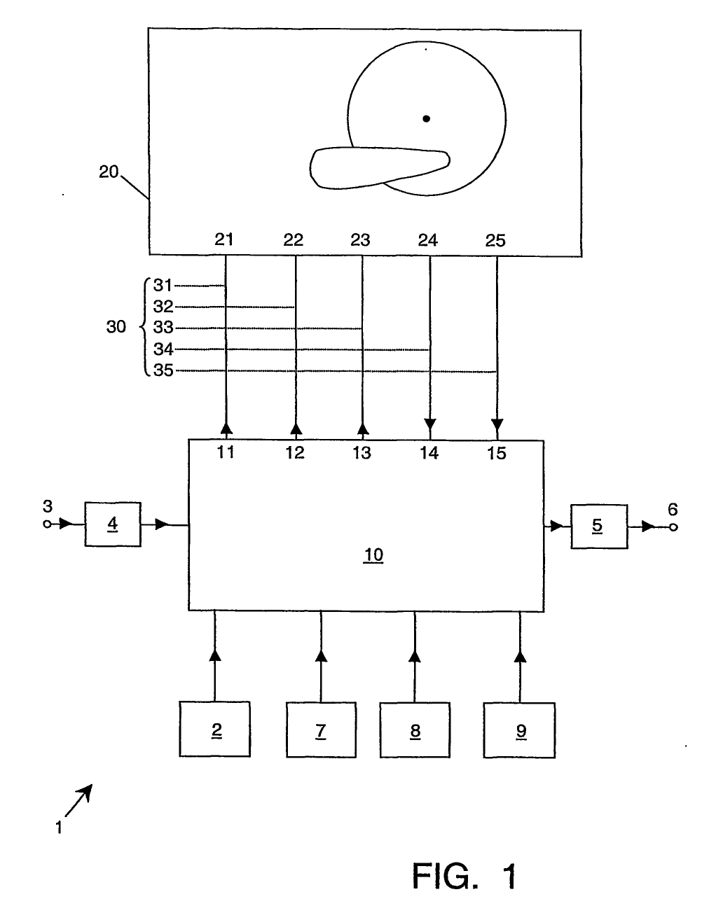

FIG. 1 schematically illustrates a consumer apparatus,

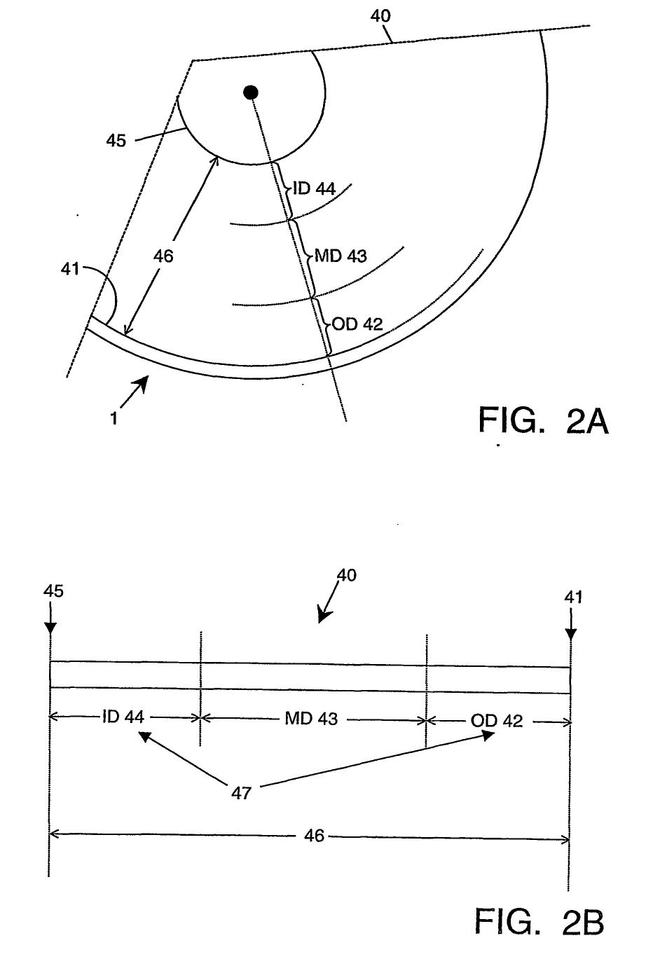

FIG. 2A schematically illustrates a part of a storage disc,

FIG. 2B schematically illustrates the storage space of the storage disc,

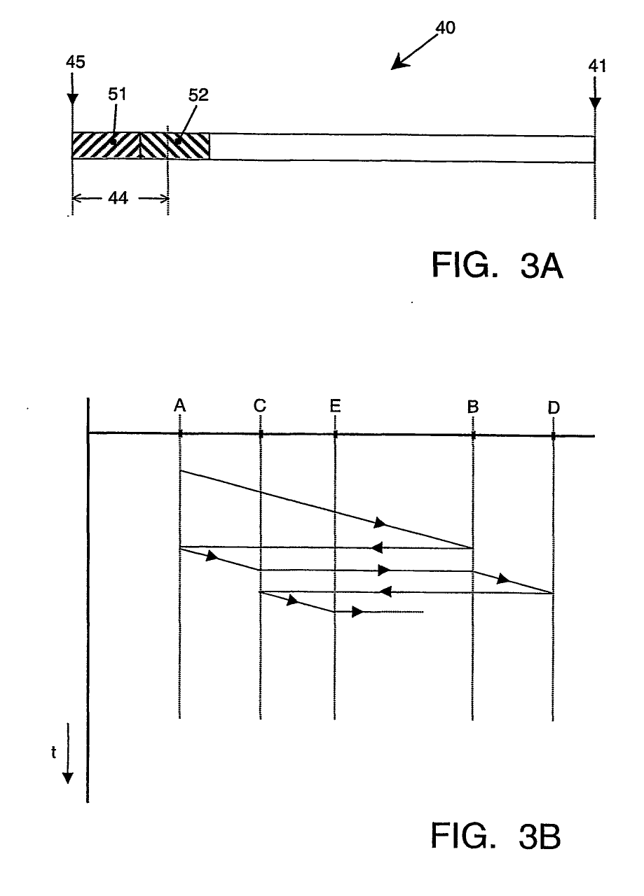

FIG. 3A schematically illustrates the storage space of the storage disc,

FIG. 3B schematically illustrates a recording operation,

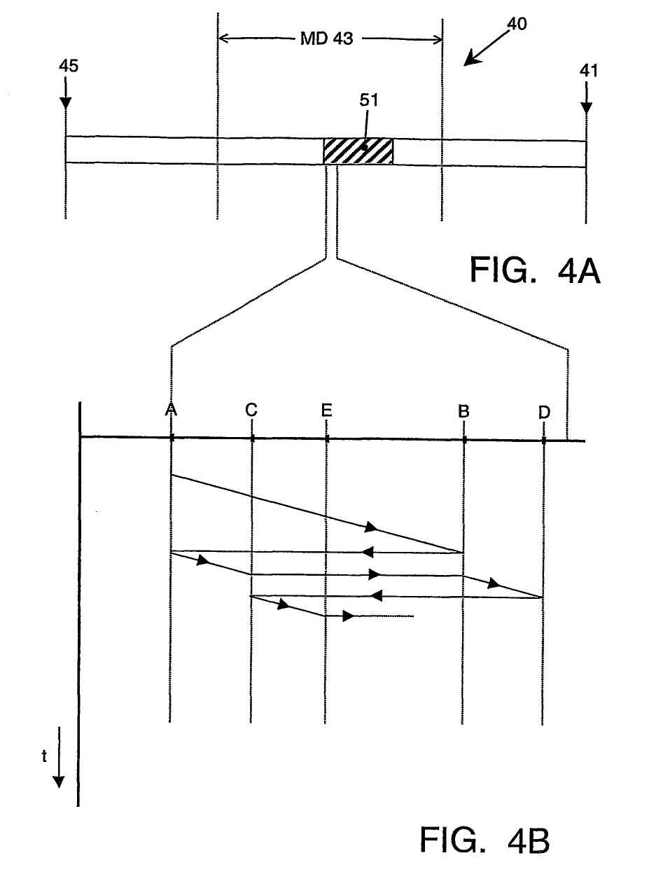

FIG. 4A schematically illustrates the storage space of the storage disc,

FIG. 4B schematically illustrates a recording operation,

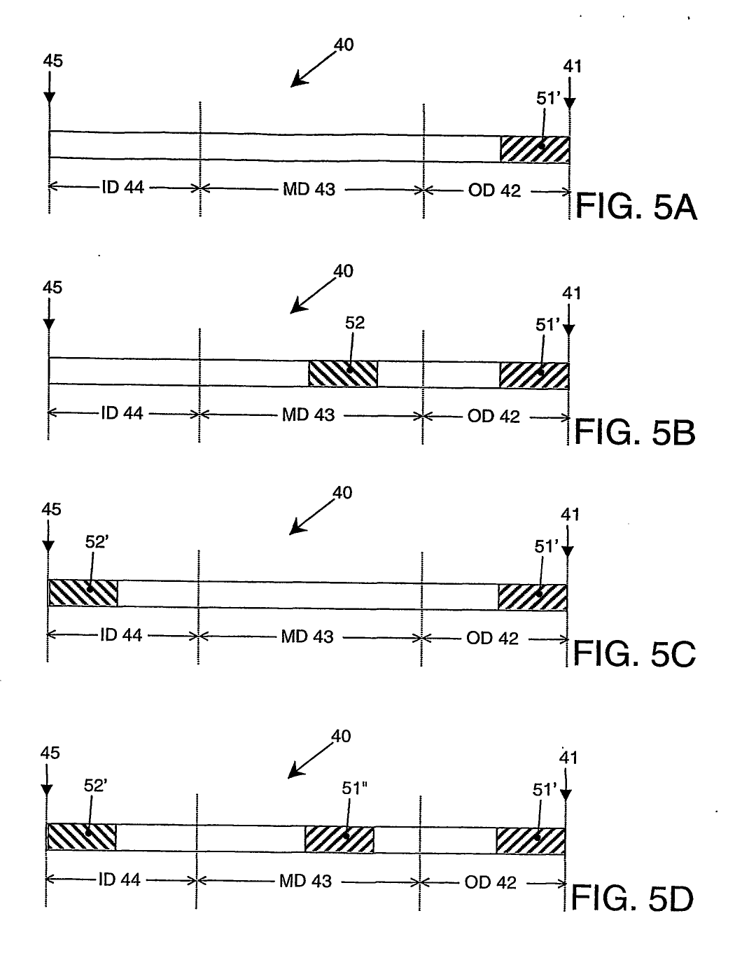

FIGS. 5A-D schematically illustrate the storage space of the storage disc,

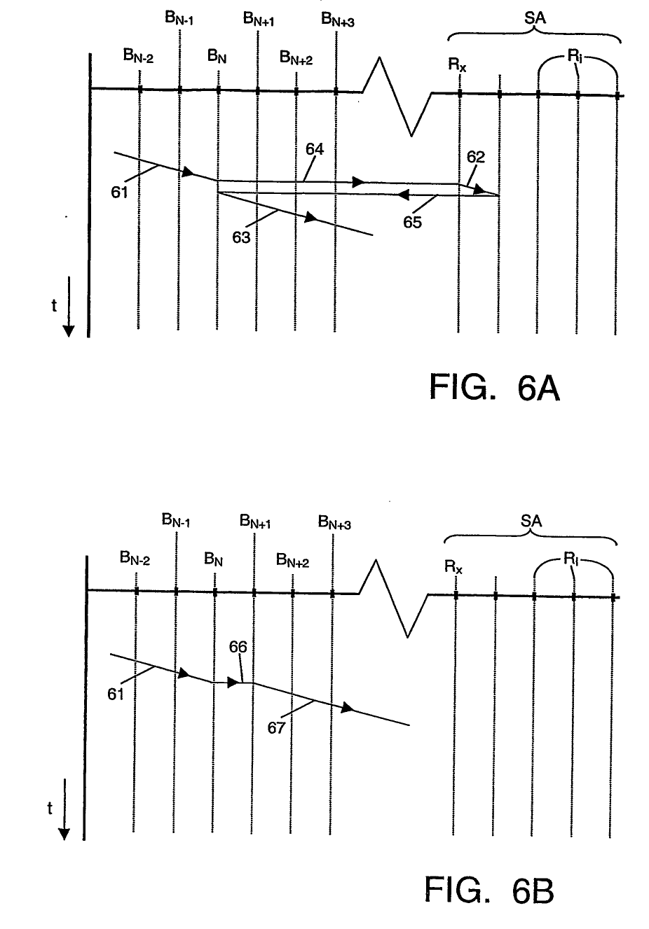

FIG. 6A schematically illustrates a recording operation in case of a defect according to prior art, and

FIG. 6B schematically illustrates a recording operation in case of a defect in accordance with the present invention.

FIG. 1 schematically illustrates a consumer apparatus 1, which for the sake of exemplary discussion may be considered to be a television apparatus, comprising a storage facility provided by a built-in HDDU 20. For controlling the data traffic to and from the HDDU 20, the apparatus 1 comprises a scheduler 10, which communicates with the HDDU 20 over a communication link 30. The communication from scheduler 10 to HDDU 20 comprises data for storage, storage commands, playback commands; the communication from HDDU 20 to scheduler 10 comprises playback data and error messages.

As will be clear to a person skilled in the art, data signals and command signals are actually mixed according to a predefined format in digital communication. However, for sake of clarity, the transfer of data and commands will be considered as different communication channels, with corresponding inputs and outputs of the scheduler 10 and the HDDU 20. Thus, it will be considered that the scheduler 10 has a data output 11 for data to be written, a write command output 12 for issuing write commands, a read command output 13 for issuing read commands, a data input 14 for receiving playback data, and a status input 15 for receiving status information, error messages, and the like. Further, it will be considered that the HDDU 20 has a data input 21 for receiving data to be written, a write command input 22 for receiving write commands, a read command input 23 for receiving read commands, a data output 24 for outputting playback data, and a status output 25 for outputting status information, error messages, and the like. A write data link 31 connects the scheduler's data output 11 to the HDDU's data input 21; a write command data link 32 connects the scheduler's write command output 12 to the HDDU's write command input 22; a read command data link 33 connects the scheduler's read command output 13 to the HDDU's read command input 23; a read data link 34 connects the HDDU's data output 24 to the scheduler's data input 14; a status link 35 connects the HDDU's status output 25 to the scheduler's status input 15.

The apparatus 1 further comprises user input means 2, which suitably may comprise command buttons, switches, a key board, etc, allowing the use to express his wishes. The various buttons etc are not shown individually for sake of simplicity.

The apparatus 1 further comprises a program input 3, for receiving an Audio/Video program, for instance from an antenna, a cable distribution network, etc. Through a data processing circuitry 4, a received program stream is forwarded to the scheduler 10.

The apparatus 1 further comprises a program output 6, for providing a program output signal to a rendering device such as a display screen, a loudspeaker, etc. Through a data processing circuitry 5, the scheduler 10 forwards data to the output 6.

FIG. 2A schematically shows a plan view of a part of a disc 40 of the HDDU 20. It is noted that the HDDU may contain one or more of such discs. The disc 40 contains, as is generally known, a plurality of tracks, which are not shown individually for sake of simplicity. An outermost track 41 defines an outer radius of a recordable disc area 46, while an innermost track 45 defines an inner radius of this recordable disc area 46. The recordable disc area 46 comprises an outer area adjacent the outermost track 41, indicated as outer disc area OD 42; an inner area adjacent the innermost track 45, indicated as inner disc area ID 44; and a central area between OD 42 and ID 44, indicated as mid-disc area MD 43. By way of example, it may be assumed that the OD 42, MD 43 and ID 44 have mutually the same radial size.

In FIG. 2B, the recordable disc area 46 is schematically illustrated as a straight ribbon.

FIG. 3A is a representation similar to FIG. 2B, illustrating operation of a prior art scheduler. Suppose that the disc 40 is still blank, and that the scheduler receives a command to record a first program 51. Such prior art scheduler may start writing from the first available address in the recordable disc area 46, for instance starting from the inner track 45 outward, i.e. in the inner disc area ID 44.

FIG. 3B shows the recording 51 on a larger scale. A, C, E, B, D are points on the ID 44. The vertical axis represents time. The movements of a pickup are shown as a path in the Figure.

Suppose that, initially, the user only wishes the apparatus 1 to record the program 51; writing then continues gradually from a startpoint A onwards, illustrated as a sloping line from A to B.

Suppose that, when recording has progressed to point B, the user wishes to start viewing the program 51. The scheduler then orders a playback from starting location A to a location C to fill a playback buffer (not shown) while the input program is stored in a write buffer. The pickup jumps to location A, illustrated as a horizontal line from B to A, and moves gradually from point A to point C during playback, illustrated as a sloping line from A to C.

The scheduler then continues writing from location B to a location D, reading the data to be stored from the write buffer, while display of the program continues from the playback buffer. The pickup jumps to location B, illustrated as a horizontal line from C to B, and moves gradually from point C to point D during writing, illustrated as a sloping line from B to D.

This procedure is continued as long as simultaneous writing and reading continues. It involves repeated seek operations, i.e. jumps from B to A, from C to B, from D to C, etc. These jumps generate noise.

FIGS. 4A and 4B are representations similar to FIGS. 3A and 3B, respectively, illustrating operation of a scheduler 10 in accordance with the present invention, being set for the same task. Instead of starting at the first available address in the recordable disc area 46, the scheduler 10 of the present invention is designed to select the address of startpoint A on the basis of minimum noise considerations. In a simple embodiment, the scheduler 10 may select startpoint A in the center of MD 43. In a more elaborate embodiment, the scheduler 10 may have an associated memory 7 comprising noise profile data of the disc 40, in which case the scheduler 10 may select startpoint A to coincide with a lowest-noise track, i.e. a track associated with the lowest amount of noise generation.

Again, in a time-shifted playback mode, jumps from B to A, from C to B, from D to C, etc are made, these jumps creating noise. However, the noise level is reduced as compared with prior art, because the recording is made in a low-noise area, i.e. MD 43.

It may be that the user wishes to keep the first program 51 for a longer time, even after playback. Suppose that, some time later, the user wishes to record a second program. In the prior art, such second program 52 would be stored starting from a location where the previous program 51 ended (FIG. 3A). According to the present invention, such second program is also written in a low-noise area, with the lowest amount of expected noise. However, it is inevitable that the preferred mid-disc area 43 gets full when it is being filled by writing. This would mean that later programs can not be stored at the preferred location any more.

According to a preferred aspect of the present invention, the scheduler 10 is designed to copy the recording of first program 51 to another location outside the preferred low-noise area 43, for example to a location 51′ adjacent the outer track 41 (see FIG. 5A). Then, the preferred low-noise area MD 43 is free for the scheduler 10 to write the second program 52 (see FIG. 5B).

In the following, the low-noise area MD 43 will also be indicated with the phrase “quiet area”, while all parts of the recordable disc area 46 outside said low-noise area MD 43 will in general be indicated as noisy area 47.

It is noted that, in the Figures, the size of the programs is shown exaggeratedly large in comparison to the size of the storage areas. In reality, a quiet storage area 43 is capable of containing many recorded programs. Nevertheless, the storage capacity in quiet storage area 43 is not indefinite, and it may be desirable to relocate one or more programs from quiet area MD 43 to noisy area 47. This applies especially to programs which are intended for long-term storage. Therefore, in a special embodiment of the present invention, the scheduler 10 is capable of receiving from user input 2 a signal indicating a user-intention regarding term of storage (i.e. whether a recording is intended for long-term storage, for instance), and to selectively relocate programs primarily only if indicated for long-term storage. If more storage capacity of the quiet area 43 needs to be made available for recording, the scheduler 10 may relocate programs which are indicated for mid-term storage.

Relocating a recording from quiet area 43 to elsewhere (51 to 51′) is done by the scheduler 10 at a moment when the user is not using the apparatus 1, and user commands are not expected, for instance when the user has put the apparatus in a sleep mode or idle mode. In order to assure that possible noise generated by the relocation process is as little disturbing as possible, the scheduler 10 may be provided with a time-of-day clock 8, and may be designed to restrict any relocation process to a predetermined period. This period may for instance be a daytime period, for instance between 09:00 and 16:00; this is a suitable choice for cases where the user appliance is located in the user's bedroom. Alternatively, said period may be selected to be a night period, for instance between 01:00 and 06:00; this is a suitable choice for cases where the user appliance is located in the user's living room, based on the assumption that the user is not present in that room during the night.

It may even be that the hours of said period are user-selectable.

Even in a straight-forward recording or reading mode, i.e. without time-shift write/read, reading or writing a disc causes noise (spinning noise), which noise is less in a quiet area 43 as compared to the noisy area 47. Therefore, always writing in the quiet area 43 may be a desirable strategy. However, depending on circumstances, it may be that noise considerations do not play an important role, and in such cases the scheduler may be designed to opt for another strategy. For instance, in the case of a program being recorded during a time of day when a user is away, any noise generated will not annoy the user. In such case, it may be desirable to write the program in noisy area 47, so that quiet area 43 is not used in this case, and the possible need for relocation is avoided.

In this respect, the scheduler 8 may be provided with a time-of-day clock 8, and may be designed to determine whether noise considerations apply on the basis of the time of day.

Also, when the user inputs a command to the scheduler to record a certain program, the scheduler may be designed to receive user input indicating whether the program is to be recorded in a silent mode or whether the user is indifferent about the amount of noise generated.

In the above, it is explained that a scheduler in accordance with the present invention is capable of always recording a program 52 in a quiet area MD 43, because earlier recordings (51) may be relocated (51′) to a location outside such quiet area MD 43 (provided, of course, that the disc 40 still has storage capacity inside such quiet area MD 43). As a consequence, many programs will be stored in noisy area 47. As explained above, this applies primarily to programs indicated for long-term storage. When such programs are to be played, annoying noise may be experienced when the program is played in a time-shift mode as explained earlier.

Therefore, it is desirable that a program is located in quiet area MD 43 when being played. In order to offer this advantage, a scheduler 10 according to a further elaboration of the present invention is designed to be capable of receiving from user input 2 a signal indicating a user-intention regarding time of playback (for instance intended date of playback), and to record into said quiet area MD 43 a copy of a program indicated for playback. This operation is illustrated in FIGS. 5C-D. FIG. 5C illustrates that the second program 52 has been relocated (52′) to noisy area 47, in this case ID 44, so that quiet area 43 is fully available for recording. FIG. 5D illustrates that a copy 51″ of the relocated first program 51′ has been recorded in quiet area 43.

The time of the copying process may be selected in a manner similar as described above with respect to the relocation process from quiet area to noisy area.

It is noted that the relocation process is, in fact, a copying process. In the case of relocation (51→51′), the original recording (51) is no longer needed, and the storage space occupied by the original recording is made available for future recordings. In contrast, in the case of copying (51′→51″) a program from noisy area to quiet area before playback, it is very well possible that the user wishes to keep this program longer. Then, the original recording (i.e. the recording 51′ in de noisy area) is to be maintained. The copy recording 51″ (i.e. the recording in de low-noise area) may be discarded directly after playback, but it may also be that the user wishes to play this program once more in the near future, in which case it is more efficient to maintain this copy recording 51″ also, for a second or further playback.

It is noted that jumps from one location to another, such as explained with reference to FIGS. 3B and 4B in the context of time-shift write/read, are not the only source of noise. Even without such jumps, reading or writing a disc causes noise (spinning noise), which noise is less in a quiet area 43 as compared to the noisy area 47. However, jumps are an important source of noise, and therefore it is desirable to reduce the occurrence of jumps as much as possible.

In the above, recording and playing are depicted (FIG. 3B, FIG. 4B) as involving a relatively smooth movement of pickup over the storage area 46. However, as will be known to persons skilled in the art, the storage area is divided into blocks having a certain address, and in practice it may happen that one or more blocks are defective so that recording is not possible there. In order to handle such a situation, a disc 40 contains one or more areas where blocks are reserved for use as replacement of a defective block.

FIG. 6A is a graph similar to FIG. 3B but on a larger scale. The horizontal axis indicates storage locations, wherein individual blocks are indicated as Bi, i being an integer index distinguishing individual blocks. SA indicates a spare area, containing reserved blocks Ri.

Suppose that block BN is defective. Normal recording takes place for blocks B(N−2), B(N−1), until block BN is reached, indicated by a first sloping line 61. The data intended for block BN are recorded in a replacement block Rx, indicated by a second sloping line 62, after which normal recording continues for blocks B(N+1), B(N+2), etc, indicated by a third sloping line 63. This replacement recording involves a first jump from block BN to spare area SA, indicated by a first horizontal line 64, and a second jump back from spare area SA to block B(N+1), indicated by a second horizontal line 65. Of course, the defective area may be larger than just one block.

Reallocation of the data intended for storage in block BN to a replacement block Rx takes place in the HDDU 20. Normally, the scheduler 10 does not have any control over such reallocation operation. In fact, it may even be that the HDDU 20 does not communicate to the scheduler the fact that reallocation has taken place. However, in a preferred arrangement, the HDDU 20 communicates to the scheduler 10 the fact that reallocation has taken place, and the HDDU 20 may even communicate to the scheduler 10 the reallocation address Rx for this defective block BN.

In a preferred embodiment, the scheduler 10 is designed to avoid writing in defective blocks in order to avoid the occurrence of reallocation jumps. In a defective area memory 9 associated with the scheduler 10, the scheduler 10 stores a list of addresses of blocks BN which, according to information received from the HDDU 20 during writing or reading, are defective. During a write operation, the scheduler 10 consults this defective area memory 9. When writing has progressed to block B(N−1), the scheduler 10 will know from the defective area memory 9 that the next block BN is defective, and the scheduler 10 will skip this block (line 66) and continue writing at block B(N+1) (line 67). This operation is illustrated in FIG. 6B.

It should be clear to a person skilled in the art that the present invention is not limited to the exemplary embodiments discussed above, but that various variations and modifications are possible within the protective scope of the invention as defined in the appending claims.

For instance, in the above, the present invention is explained mainly in the context of noise generated by jumps (seek noise). However, noise may also be generated due to the vibrational modes of the spinning disc, which may be excited due to the position of the pickup and its disturbing effect on the airflow which causes forces exerted on the disc.

In the above, the operation of the scheduler in accordance with the present invention is explained mainly in the context of seeking a specific location for writing information. However, the present invention is not limited to writing operations. It may be that a certain program is stored in more than one location on disc; this is especially the case if the scheduler has performed a relocation of a program, as explained in the above. Then, if the scheduler receives a read command, it has a choice between two or more program locations; in accordance with the present invention, the scheduler will read the program from the program location associated with the least noise.

In the above, the operation of the scheduler in accordance with the present invention is explained mainly in the context of seeking a specific location for writing or reading information. Apart from selecting a storage location where the seek noise will be minimal, it is also possible that the seek strategy is adapted to circumstances, with a view to noise generation. For instance, the amount of seek noise generated in the more-noise area 42, 44 may be reduced by reducing the seek rate.

In the above, it is explained that a scheduler according to the present invention is noise-aware, and is capable of operating in a quiet mode in which the scheduler makes choices on the basis of minimizing the amount of noise involved. It is possible that the scheduler is always operating in such quiet mode. However, there are circumstances where such quiet mode is not necessary. For instance, it may be that quiet mode is not necessary during daytime, when it is expected that noise from the surroundings will camouflage the seek noise, whereas operation in quiet mode is required during night. It is also possible that the scheduler is associated with a means for ascertaining the presence/absence of people in its vicinity, in which case the scheduler may be designed to operate in quiet mode when it determines that at least one person is present or to operate in a non-quiet mode when it determines that no persons are present. Thus, a scheduler in accordance with the present invention is preferably capable of operating in at least two modes, a first mode or quiet mode wherein the scheduler is noise-aware and makes choices with a view to noise-reduction, and a second mode or non-quiet mode wherein the scheduler does not take any considerations of noise-reduction into account when making choices.

It is possible that the decision whether to operate in quiet mode or in non-quiet mode is user-selectable. It is also possible that the scheduler is capable of deciding itself to operate in quiet mode or in non-quiet mode on the basis of one or more predetermined criterions.

In the above, the present invention is explained with reference to noise generation as being annoying to humans. However, writing and reading operations are also associated with mechanical vibrations, which may disturb or interfere with other devices which are sensitive to vibrations. For such cases, the same considerations apply to vibrations as mentioned above in the context of noise. Therefore, in this text, especially in the claims, the expression “amount of noise” will also mean “amount of vibrations”.

Thus, the present invention succeeds in providing a scheduler 10 for a user appliance 1, and a user appliance comprising such scheduler, for co-operation with a disc storage device 20. The scheduler is designed to perform a quiet writing/reading strategy, i.e. to record or read user data into or from storage space of the rotary disc storage device, at storage locations where the amount of noise generated is as little as possible. The scheduler has an associated memory 7 with information on the noise behavior of the disc storage device 20 as a function of the storage location. When selecting a storage location for writing or reading, the scheduler is designed to consult the memory 7 and to select a quiet storage area 43.

1. Scheduler for an apparatus comprising a disc storage device,
the scheduler being designed for receiving data and writing the data in storage space of a storage medium of the disc storage device;
the scheduler being designed to operate in a first mode wherein the scheduler, when setting at least one operating parameter, sets such operating parameter with a view to low noise generation.

2. Scheduler according to claim 1, wherein the scheduler is always operating in said first mode.

3. Scheduler according to claim 1, the scheduler also being capable of operating in at least a second mode in which the scheduler, when setting said operating parameter, sets said operating parameter without noise reduction.

4. Scheduler according to claim 3, wherein the scheduler, when operating in said second mode, sets said operating parameter to a value or selection different from the one when operating in said first mode, while the value or selection of said operating parameter as set in said first mode results in an amount of noise generation less than the amount of noise associated with the value or selection of said operating parameter as set in said second mode.

5. Scheduler according to claim 2, wherein the operative mode of the scheduler is user-selectable, and wherein the scheduler is responsive to user input to select its operative mode as either said first mode or said second mode.

6. Scheduler according to claim 2, wherein the scheduler is capable of determining the presence of at least one person in the vicinity of the said apparatus, and wherein the scheduler is designed to select its operative mode as said first mode when it determines the presence of at least one person, and wherein the scheduler is designed to select its operative mode as said second mode when it determines the absence of persons.

7. Scheduler according to claim 2, provided with a time-of-day clock, the scheduler being designed to select its operative mode depending on the time of day.

8. Scheduler according to claim 1, the scheduler being designed to generate write commands for the disc storage device, wherein said at least one operating parameter is a target address of a storage location in said storage space where the data is to be written to.

9. Scheduler according to claim 1, the scheduler being designed to generate read commands for the disc storage device, wherein said at least one operating parameter is a target address of a storage location in said storage space where the data is to be read from.

10. Scheduler according to claim 8, wherein the scheduler is associated with a memory containing information on a sound characterization of the disc storage device;
wherein the scheduler is designed, when operating in said first mode, to consult the information in said memory when selecting a target address of a storage location in said storage space.

11. Scheduler according to claim 8, wherein the disc storage space comprises quiet area and noisy area; and wherein the scheduler is designed, when operating in said first mode, if there is sufficient storage space available in said quiet area as well as in said noisy area, to select target addresses within said quiet area of the storage space.

12. Scheduler according to claim 11, wherein the scheduler is designed, in said second mode, to select target addresses outside said quiet area of the storage space.

13. Scheduler according to claim 8, wherein the disc storage space comprises mid-disc area, inner disc area and outer disc area;
wherein the scheduler is designed, when operating in said first mode, if there is sufficient storage space available in said mid-disc area as well as in said inner disc area or outer disc area, to select target addresses within said mid-disc area of the storage space.

14. Scheduler according to claim 13, wherein the scheduler is designed, in said second mode, to select target addresses outside said mid-disc area of the storage space.

15. Scheduler according to claim 11, wherein the scheduler is designed to relocate a recording from a quiet area of the storage space to a noisy area of the storage space.

16. Scheduler according to claim 15, wherein the scheduler is designed to perform such relocation process in response to receiving user input indicating that the recording is intended for long-term storage.

17. Scheduler according to claim 11, wherein the scheduler is designed to copy a recording from a noisy area of the storage space to a quiet area of the storage space.

18. Scheduler according to claim 17, wherein the scheduler is designed to perform such copying process in response to receiving user input indicating that the recording is to be played in the near future.

19. Scheduler according to claim 15, wherein the scheduler is designed to perform such relocation or copying process during an idle moment.

20. Scheduler according to claim 15, provided with a time-of-day clock, the scheduler being designed to perform such relocation process during a predetermined time slot.

21. Scheduler according to claim 20, responsive to user input to set said time slot in future.

22. Scheduler according to claim 1, the scheduler being designed, when operating in said first mode, to reduce seek movements when writing/reading in/from a noisy area and to increase seek movements when writing/reading in/from a quiet area

23. Apparatus comprising a disc storage medium and a scheduler according to claim 1.

24. Apparatus according to claim 23, wherein the disc storage medium comprises a hard disc drive unit.
